(19) United States
(12) Patent Application Publication
(10) Pub. No.: US 2006/0219342 A1
(43) Pub. Date: Oct. 5, 2006

(54) Pair of front and rear pneumatic tires for motorcycles and method of improving the performance on both wet and dry ground of a motorcycle equipped with said pair

(76) Inventor: Gunter Steinbach, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/560,890

(22) PCT Filed: Jul. 4, 2003
(86) PCT No.: PCT/EP03/07261

§ 371 Date: Apr. 5, 2006

(51) Int. Cl. B60C 11/03

(52) U.S. Cl. 152/209.11

(57) ABSTRACT

A pair of motorcycle tires includes front and rear tires. The front tire's tread band includes at least one circumferential groove and a plurality of transverse grooves. The at least one circumferential groove extends at an equatorial plane of the front tire within a central zone of the tread band. The transverse grooves include axially inner ends lying within the central zone that alternately extend from the central zone toward axially opposite shoulder zones. At least some of the transverse grooves are connected to the at least one circumferential groove. The rear tire's tread band includes an area defining a substantially null sea/land ratio within a central zone of the tread band. The central zone of the rear tire's tread band has a width greater than or equal to about 5% and less than or equal to about 30% of an axial development of the rear tire's tread band.

### BACKGROUND OF THE INVENTION

The present invention relates to pair of pneumatic tires comprising a front tire and a rear tire to be mounted, respectively, on a front wheel and on a rear wheel of a motorcycle, each of said front and rear tires comprising a tread band provided with a plurality of grooves.

### PRIOR ART

In the field of pneumatic tires for motorcycles and in particular in the field of pneumatic tires for the so-called high-performance and high-weight “sport-touring” motorcycles, one of the most difficult problems to be solved by tire manufactures is that of improving the performance on wet grounds and the kilometric yield, wear regularity and traction characteristics of the tires while finding at the same time the best possible compromise between these characteristics.

As is well known to any person skilled in the art, such a problem is particularly difficult to be solved in view of the fact that these characteristics are conflicting with one another since the performance on wet ground is largely related to the presence in the tread band of a sufficient number of grooves capable of draining the water present under the ground contacting area of the tires, while the kilometric yield, the wear regularity and the traction characteristics of the tires—on the contrary—would be beneficially influenced by reducing the number of grooves to the smallest possible extent.

This problem which is already difficult per se, is additionally further complicated by the fact that the performance on wet ground should be ensured both during running along straight stretches and along a bend.

### SUMMARY OF THE INVENTION

According to the present invention, the Applicant has perceived that the problem of improving both the performance on wet ground and the kilometric yield, wear uniformity and traction characteristics of motorcycle tires may be solved by affording this problem from an overall perspective, that is by taking into consideration both the front and the rear tire at one time so as to find the way for improving their performance simultaneously.

In the light of this perception, the Applicant has found that the aforementioned problem may be solved by combining together a front and a rear tire each having a tread pattern provided with special design characteristics.

Therefore, the present invention provides a pair of pneumatic tires for motorcycles wherein the tread band of the front tire comprises:
a) at least one circumferential groove extending at the equatorial plane of the front tire within a central zone extending astride said equatorial plane;
b) a plurality of transversal grooves having an axially inner end lying within the central zone of the tread band and alternately extending from said central zone towards axially opposite shoulder zones of the tread band external to said central zone, at least some of said transversal grooves being connected to said at least one circumferential groove;

and wherein the tread band of the rear tire comprises an area defining a substantially null sea/land ratio within a central zone of the tread band extending astride the equatorial plane of the rear tire and having a width of from about 5% to about 30% of the axial development of the tread band.

In the following description and in the appended claims, the term: “axial development” of the tread band or of any portion thereof, is used to indicate its extension in width as measured along the peripheral surface of the tire or, in other words, its development along a planar surface.

According to the invention, the Applicant has found that by adopting a tread band design as defined hereinabove in the front tire, the latter achieves a water draining capacity under the ground contacting area both during running along straight stretches and along a bend which is such that the rear tire travels on a “track” substantially free from water.

This advantageous technical effect may be ascribed to the water draining action exerted by both the at least one circumferential groove extending at the equatorial plane of the front tire and the aforementioned plurality of transversal grooves having an axially inner end lying within the central zone of the tread band.

Thanks to this advantageous technical effect achieved by the front tire, the tread band of the rear tire may be suitably designed to optimize its traction performance and wear resistance by providing said area defining a substantially null sea/land ratio within a central zone of the tread band extending astride the equatorial plane of the rear tire and having a specified axial development.

In addition, the at least one circumferential groove extending at the equatorial plane of the front tire also acts as a hinge element during the tire running thereby achieving the additional advantageous technical effect of increasing the running stability of the front tire.

Accordingly, the pair of tires of the invention allows to achieve the following important advantages with respect to the tires of the prior art for the same type of use:
a) an improvement of the front tire capacity of draining off the water present under the tire ground-contacting area so as to better control any aquaplaning phenomena;
b) an improvement of the driving stability of the front tire on straight stretches;
c) an improvement of the traction performance of the rear tire;
d) an improvement of the wear uniformity of the rear tire with a substantial elimination of those phenomena of irregular and dishomogeneous wear of the rubber portions of the tread band referred to in the art by the term: “chunking”;
e) an improvement of the wear resistance of the rear tire and, along therewith, of the kilometric yield of the tire.

In a preferred embodiment of the invention, the central zone of the tread band of the front tire has a width of from about 10% to about 35% of the axial development of the tread band.

The water draining capacity of the front tire can be increased by providing a suitable number of transversal grooves having an axially inner end lying within the very central zone of the tread band which is delegated to drain the water present under the ground contacting area away from the latter.

Preferably and in order to optimize the water draining capacity of the front tire, the central zone of the tread band of the front tire has a sea/land ratio between about 15% and about 30%.

In the following description and in the appended claims, the term: “sea/land ratio” of the tread band or of any portion thereof, is used to indicate the ratio between the area occupied by the grooves present in tread band or in any portion thereof and the total area of the tread band or, respectively, of any portion thereof.

According to a particularly preferred embodiment of the present invention, the tread band of the front tire further comprises axially opposite intermediate side zones lying between the central zone and the shoulder zones of the tread band, which intermediate side zones are provided with a specific width and with a specific sea/land ratio.

Advantageously, these axially opposite intermediate side zones further enhance the water draining capacity of the front tire when the tire travels along a bend, i.e. when the tire is inclined to provide the camber thrust necessary to counterbalance the centrifugal force.

According to this preferred embodiment, each of said intermediate side zones has a width of from about 15% to about 35% of the axial development of the tread band and a sea/land ratio between about 15% and about 35%.

In accordance with another preferred embodiment of the invention, the transversal grooves formed in the tread band of the front tire are substantially curvilinear so as to conform as much as possible to the so-called wear waves of the tread band.

Such a conformation of the grooves advantageously allows to reduce the wear of the tread band and to improve the wear uniformity and also contributes to reduce the tire noise during running of the vehicle.

Preferably, furthermore, the transversal grooves formed in the tread band of the front tire define with the running direction of the front tire an angle of from about 30° to about 60° and, still more preferably, of from about 40° to about 50°.

In the following description and in the appended claims, all the angles defined by the grooves in the front tire with its running direction are intended to be the angles defined by:
a) the tangent to the grooves at the intersection between the grooves and a circumferential line bisecting each of the half portions of the tread band defined by the equatorial plane of the front tire, with
b) the running direction of the front tire,

as as measured upstream of the grooves.

In the following description and in the appended claims, the terms: “upstream” and “downstream” are used to indicate—with reference to the position of the grooves—those parts of the tread band that are stressed or get in touch with the ground during the tire rolling before and, respectively, after said grooves.

A substantial increase of the water draining capacity of the front tire during braking with a consequent improvement of the braking behavior of the tire, with a reduction in the braking distance of the motorcycle can be achieved.

Preferably, just to better follow the aforesaid wear waves, the transversal grooves formed in the tread band of the front tire have a curvature center positioned upstream of the same at the axially opposite intermediate side zones of the tread band, external to said central zone.

In such intermediate side zones, the transversal grooves formed in the tread band of the front tire preferably have a curvature radius of from about 40 to about 200 mm and, more preferably, of from about 60 to about 120 mm as measured from a curvature center positioned along a circumferential line bisecting each of the half portions of the tread band defined by the equatorial plane of the front tire.

In this way, it was observed that the water draining effect of the transversal grooves formed in the tread band of the front tire may advantageously be optimized while maintaining the aforementioned effects of wear reduction of the tread band and wear uniformity improvement, while contributing at the same time to reduce the tire noise during running of the vehicle.

According to a preferred embodiment of the present invention, at least some of the transversal grooves formed in the tread band of the front tire are connected to said at least one circumferential groove.

In this way, it was observed that the water draining effect of the tread band of the front tire within the aforementioned central zone may advantageously be optimized.

According to a preferred embodiment of the present invention, the transversal grooves formed in the tread band of the front tire are circumferentially distributed along the tread band in axially opposite groups comprising at least two transversal grooves.

Preferably, said axially opposite groups of transversal grooves are circumferentially staggered.

Also in this case, it was observed that by adopting this preferred groove arrangement the water draining effect of the tread band of the front tire may advantageously be optimized.

According to a preferred embodiment of the present invention, the front tire further comprises at least one transversal groove formed in the tread band on either side of the equatorial plane of the tire between said axially opposite and circumferentially staggered groups of transversal grooves.

Advantageously, this additional circumferentially “intermediate” transversal groove exerts the advantageous double function of increasing the water draining capacity of the tread band while optimizing the wear regularity thereof by helping to achieve a proper balance between the area occupied by the grooves and the area occupied by the rubber portions of the tread band.

In accordance with this embodiment, this additional circumferentially “intermediate” transversal groove is preferably provided with an axially inner end substantially lying at the borderline between the central zone and the axially opposite intermediate side zone of the tread band.

Thanks to preferred arrangement, the water draining capacity of the tread band when the tire travels along a bend may advantageously be furtler enhanced.

Preferably, furthermore, the transversal grooves formed in the tread band of the front tire are substantially parallel to one another.

Such a conformation of the grooves, advantageously allows to reduce the wear of the tread band and contributes to reduce both the tire noise during running of the vehicle and the onset of undesired vibrations during running.

According to a preferred embodiment of the present invention, the aforementioned at least one circumferential groove formed in the tread band of the front tire axially crosses the equatorial plane of the front tire in a substantially winding fashion.

More specifically, said at least one circumferential groove preferably comprises a plurality of curvilinear segments having respective circumferentially-staggered centers of curvature positioned at opposite sides of the equatorial plane of the front tire.

Advantageously, this geometrical configuration of the circumferential groove allows to increase the running stability of the front tire when traveling along uneven road surfaces and especially along road surfaces having longitudinal channels such as, for example, the so-called “rain grooves” formed in the road surface in the United States or those which may be formed in the road when the asphalt surface thereof is removed for replacement.

Preferably, the curvilinear segments of said at least one circumferential groove have a curvature radius of from about 40 to about 200 mm and preferably of from about 60 to about 120 mm so as to advantageously optimize the running stability of the front tire.

According to a preferred embodiment of the present invention, the rear tire has a curvature ratio lower than the front tire.

In the following description and in the appended claims, the term: “curvature ratio” is used to indicate the ratio between the height of the tread crown from the line passing by the axially opposite ends of the tread band or “camber” of the tread band, said line being measured at the equatorial plane, on the one hand, and the distance between said axially opposite ends of the tread band on the other hand.

According to a preferred embodiment of the present invention, the tread band of the rear tire comprises a plurality of transversal grooves alternately extending from the central zone towards axially opposite shoulder zones external to said central zone.

Thanks to this additional feature, it is advantageously possible to profitably attain a suitable water draining capacity of the rear tire while running along a bend to the benefit of the overall performance of the pair of tires on wet grounds.

During deep bending, in fact, the rear tire can partly or completely get out of the “track” of the front tire thus loosing the aforementioned advantage of running on a ground substantially freed from water. The transversal grooves optionally present on the tread band of the rear tire advantageously provide to said tire a water draining capacity also in extreme performance conditions.

Preferably, the tread band of the rear tire further comprises axially opposite intermediate side zones lying between the central zone and said shoulder zones of the tread band, each of said intermediate side zones having a width of from about 15% to 35% of the axial development of the tread band and a sea/land ratio between about 10% and about 30%.

In this way, it is advantageously possible to optimize the water draining capacity of the rear tire both when running along a bend just in the same way as for the front tire.

According to a preferred embodiment of the present invention, the transversal grooves formed in the tread band of the rear tire are substantially curvilinear so as to conform as much as possible to the so-called wear waves of the tread band.

Such a conformation of the grooves, in fact, advantageously allows to reduce the wear of the tread band, to improve the wear uniformity and contributes to reduce the tire noise during running of the vehicle.

Preferably, the transversal grooves formed in the tread band of the rear tire form with the running direction of the rear tire an angle of from about 30° to about 60° and, more preferably, of from about 40° to about 50°, thereby achieving the advantageous technical effect of substantially increasing the water draining capacity of the leaning rear tire during braking with a consequent improvement of the braking behavior of the tire, with a reduction in the braking distance of the motorcycle.

In the following description and in the appended claims, all the angles defined by the grooves in the rear tire with its running direction are intended to be the angles defined by:
a) the tangent to the grooves at the intersection between the grooves and a circumferential line bisecting each of the half portions of the tread band defined by the equatorial plane of the rear tire, with
b) the running direction of the rear tire,

as measured downstream of the grooves.

Preferably, just to better follow the aforesaid wear waves, the transversal grooves formed in the tread band of the rear tire have a curvature center positioned upstream of the same at the opposite intermediate side zones of the tread band, external to said central zone.

In such intermediate side zones, the transversal grooves formed in the tread band of the rear tire preferably have a curvature radius of from about 60 to about 240 mm and, more preferably, of from about 80 to about 160 mm, as measured from a curvature center positioned along a circumferential line bisecting each of the half portions of the tread band defined by the equatorial plane of the rear tire.

In this way, it was observed that the water draining effect of the transversal grooves formed in the tread band of the rear tire may advantageously be optimized while maintaining the aforementioned effects of wear reduction of the tread band, wear uniformity improvement and tire noise reduction during running of the vehicle.

According to a preferred embodiment of the present invention, the transversal grooves formed in the tread band of the rear tire are circumferentially distributed in axially opposite groups comprising at least two transversal grooves.

Preferably, said axially opposite groups of transversal grooves are circumferentially staggered.

It was observed that by adopting this preferred groove arrangement the water draining effect of the tread band of the rear tire may advantageously be optimized.

According to a preferred embodiment of the present invention, the rear tire further comprises at least one transversal groove formed in the tread band on either side of the equatorial plane of the tire between said axially opposite and circumferentially staggered groups of transversal grooves.

Just in the same way as for the front tire, this additional circumferentially “intermediate” transversal groove advantageously exerts the double function of increasing the water draining capacity of the tread band, especially when the rear tire travels along a bend, while optimizing the wear regularity thereof by helping to achieve a proper balance between the area occupied by the grooves and the area occupied by the rubber portions of the tread band.

Preferably, furthermore, the transversal grooves formed in the tread band of the rear tire are substantially parallel to one another.

Such a conformation of the grooves, in fact, advantageously allows to reduce the wear of the tread band and contributes to reduce the tire noise during running of the vehicle.

According to a preferred embodiment of the present invention, at least some of the transversal grooves formed in the tread band of the rear tire are circumferentially interconnected by bridging grooves.

In this way, it is advantageously possible to enhance the water draining capacity of the rear tire when the motorcycle runs along a bend which is a particularly critical condition for the wet grip performance of the motorcycle, since the rear tire is not perfectly aligned with the front tire due to the slip angle imparted to the latter.

According to a preferred embodiment of the present invention, at least some of the transversal grooves formed in the tread band of the rear tire are provided with a tapered end portion having a width progressively decreasing towards the equatorial plane of the rear tire.

In accordance with a further aspect of the invention, a motorcycle as defined in attached claim 27 is provided, which motorcycle is equipped with a front tire and a rear tire as described above mounted, respectively, on a front wheel and on a rear wheel of the vehicle.

In accordance with a further aspect of the invention, a method of improving the performance on both wet and dry ground of a motorcycle equipped with a front tire and a rear tire as defined in attached claim 28 is provided.

Such a method comprises, in particular, the steps of:
a) enhancing the water draining capacity of the front tire under its ground contacting area within a central zone extending astride the equatorial plane of the front tire;
b) enhancing the traction capacity of the rear tire by providing a substantially null sea/land ratio within a central zone of the tread band extending astride the equatorial plane of the rear tire.

According to a preferred embodiment of the present invention, step a) is accomplished by providing the front tire with a plurality of transversal grooves having an axially inner end lying within said central zone of the tread band of the front tire and alternately extending from said central zone towards axially opposite shoulder zones of the tread band external to said central zone of the front tire.

Preferably, step a) is accomplished by providing a sea/land ratio between about 15% and about 30% within a central zone of the tread band of the front tire having a width of from about 10% to about 35% of the axial development of said tread band.

Preferably, step a) is accomplished by providing at least one circumferential groove extending at the equatorial plane of the front tire and, still more preferably, at least some of said transversal grooves are connected to this at least one circumferential groove.

In this way, it is advantageously possible to optimize the water draining capacity of the front tire under its ground contacting area both when the motorcycle runs along a straight stretch and along a bend.

According to a preferred embodiment of the present invention, the method comprises the step of further enhancing the water draining capacity of the front tire by providing a plurality of transversal grooves defining a sea/land ratio between about 15% and about 35% within axially opposite intermediate side zones lying between the central zone and said shoulder zones of the tread band, each of said intermediate side zones having a width of from about 15% to about 35% of the axial development of the tread band of the front tire.

Preferably, the aforementioned transversal grooves formed in the tread band of the front tire define with the running direction of the front tire an angle of from about 30° to about 60° and, more preferably of from about 40° to about 50°.

According to a preferred embodiment of the present invention, the method further comprises the step of enhancing the water draining capacity of the rear tire when running along a bend by providing in its tread band a plurality of transversal grooves having an axially inner end lying within the central zone of the tread band of the rear tire and alternately extending from the central zone towards axially opposite shoulder zones external to said central zone.

Preferably, said plurality of transversal grooves formed in the tread band of the rear tire define a sea/land ratio between about 10% and about 30% within axially opposite intermediate side zones lying between the central zone and said shoulder zones of the tread band of the rear tire, each of said intermediate side zones having a width of from about 15% to about 35% of the axial development of the tread band of the rear tire.

Preferably, furthermore, the transversal grooves formed in the tread band of the rear tire define with the running direction of the rear tire an angle of from about 30° to about 60° and, more preferably of from about 40° to about 50°.

Further characteristics and advantages will be more readily apparent by the following description of a preferred embodiment according to the invention, solely provided by way of non limitative indication, reference being made to the attached drawings.

### BRIEF DESCRIPTION OF THE DRAWINGS

In such drawings:

FIG. 1 shows a cross-section view of a front tire of a pair of motorcycle tires according to the invention, taken along line I-I of FIG. 2;

FIG. 2 shows a plan development of a portion of the tread band of the front tire of FIG. 1;

FIG. 3 shows a cross-section view of a rear tire of a pair of motorcycle tires according to the invention, taken along line III-III of FIG. 4;

FIG. 4 shows a plan development of a portion of the tread band of the rear tire of FIG. 3.

### DETAILED DESCRIPTION OF THE PREFERRED EMBODIMENTS

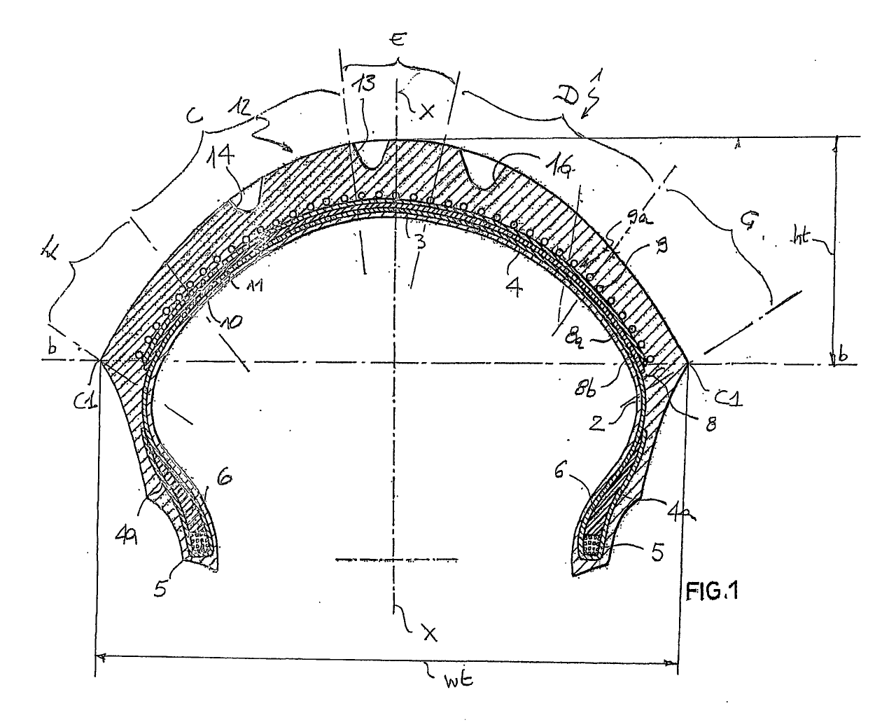

In FIG. 1, a front tire of a pair of motorcycle tires according to the invention is generally indicated at 1.

As is known, in order to have a good directional stability and a good controllability of the vehicle, the front tire must have an appropriate section of reduced width, with respect to the rear tire, which gives rise to the need of a specific transverse curvature thereof.

The extent of this transverse curvature is defined by the specific value of the ratio between distance ht (measured along the equatorial plane X-X) of the tread crown from line b-b passing by the axially opposite ends C1 of the tread band, and distance wt measured along the chord of the tire between said axially opposite ends C1.

If the axially opposite tread band ends cannot be easily identified, for instance due to lack of a precise reference such as the corner indicated by C1 in FIG. 1, the value of the tire maximum chord may be assumed as distance wt.

As has already been said, this ratio is called curvature ratio of the tire.

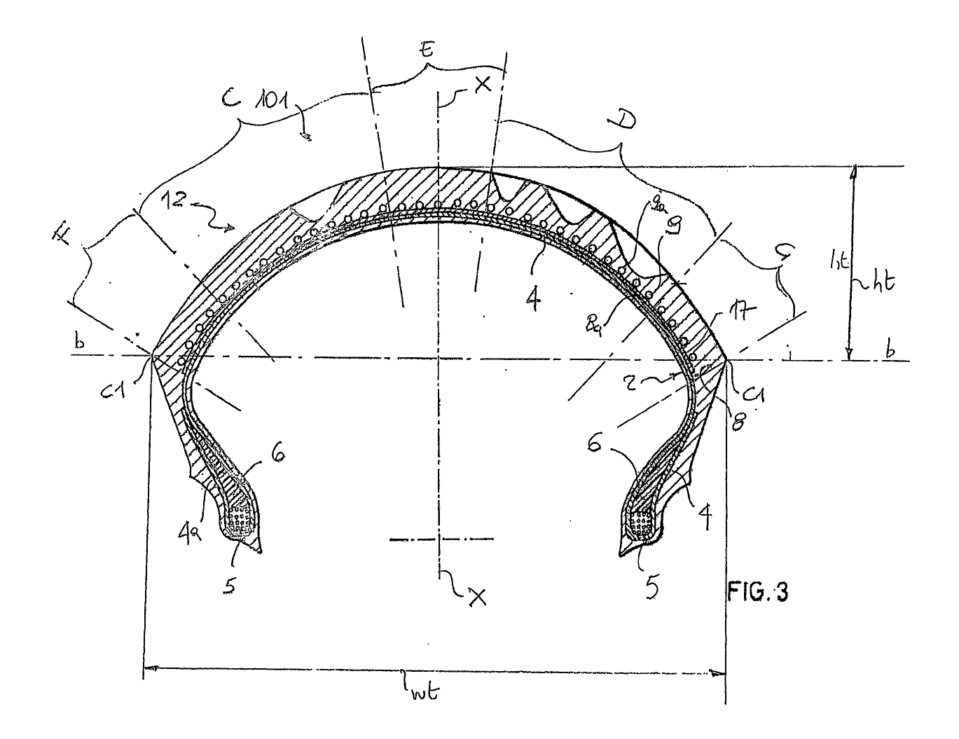

The curvature ratio for front tires of motor-vehicles is usually greater than 0.3 and in any case always greater than that of the corresponding rear tire 101 which is shown in FIG. 3 and which will be described later on.

The front tire 1 comprises a carcass structure 2 having a central crown portion 3 comprising at least one radial carcass ply 4 defining two sidewalls the opposite side edges 4a of which are externally turned up around respective annular reinforcing structures 5, usually known as “bead cores”.

On the external peripheral edge of the bead cores 5 an elastomeric filler 6 is applied which fills the space defined between the carcass ply 4 and the corresponding turned-up side edge 4a of the carcass ply 4.

A belt structure 8, which comprises at least one layer 8a including reinforcing elements is coaxially associated to said carcass structure 2.

The belt structure 8 can be constituted by a single layer 8a in which cords 9 are spirally wound on the central crown portion 3 from one end to the other of the carcass structure 2.

According to such an arrangement, the cords 9 form a plurality of circumferential coils 9a, substantially oriented according to the rolling direction of the front tire 1, which direction is usually called at “zero degree” with reference to its position with respect to the equatorial plane X-X of the tire.

Said cords 9 can be textile or metallic cords. Preferably said cords are cords made of steel having such a behavior that in a stress-deformation diagram said cords have a percent elongation exceeding 0.4%, more preferably included between 0.5 and 4%, with a load lower than 5% with respect to the tensile strength. Preferably said cords are made of high-carbon steel wires (HT), i.e. steel wires containing more than 0.9% carbon.

If textile cords are used, said cords can be made of synthetic fiber, such as nylon, rayon, PEN, PET, preferably a high-modulus synthetic fiber, in particular aramidic fiber (Kevlar® fibers, for example). Alternatively, hybrid cords can be employed which comprise at least one low-module thread (a nylon or rayon thread, for example), intertwined with at least one high-modulus thread (Kevlar®, for example).

As to possible alternative constructions of the belt structure 8, different embodiments may be possible, among which those skilled in the art may choose the most suitable one according to specific individual requirements.

Thus, for example, the belt structure 8 may additionally include—as shown in FIG. 1—a radially inner layer 8b including two strips 10, 11 of rubberized fabric provided with reinforcing elements—such as for example reinforcing cords—incorporated in an elastomeric matrix, oriented according to two preferred directions crossing each other in the two strips and preferably symmetrically inclined in relation to the equatorial plane X-X.

A tread band 12, by means of which the tire 1 gets in touch with the ground, is applied in a known manner onto the belt structure 8 described hereinabove.

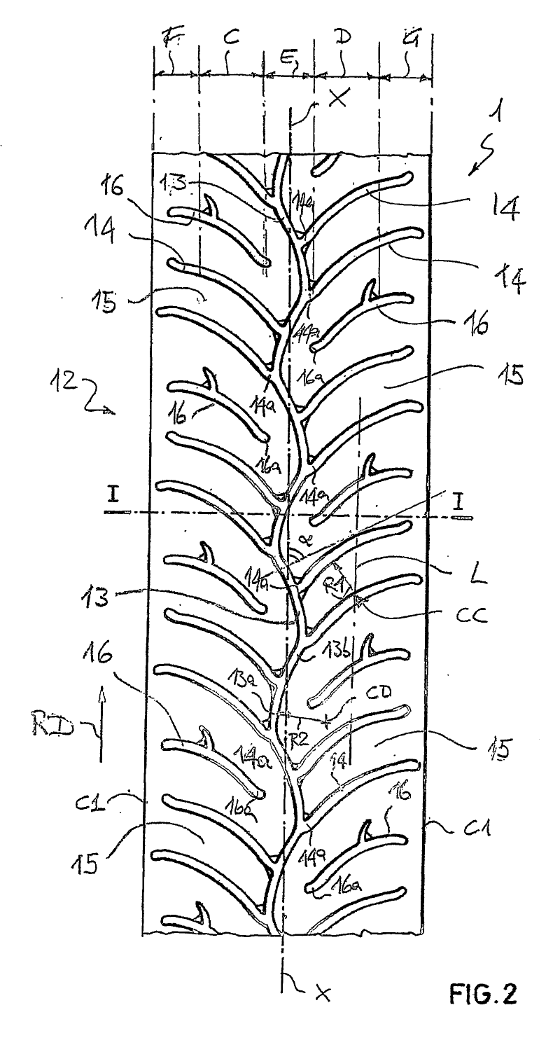

In the preferred embodiment illustrated in FIG. 2, the tread band 12 of the front tire comprises:

a) a circumferential groove 13 extending at the equatorial plane X-X of the front tire 1 within a central zone E extending astride the equatorial plane X-X, and

b) a plurality of transversal grooves 14 having an axially inner end 14a lying within the central zone E of the tread band 12 and alternately extending from the central zone E towards axially opposite shoulder zones G, F of the tread band 12 external to the central zone E.

The aforementioned circumferential groove 13 and transversal grooves 14 define in the tread band 12 a plurality of rubber portions, all indicated by reference 15, generally extending in a direction substantially transverse to the running direction of the tire which is indicated by arrow RD in FIG. 2.

Preferably, the central zone E of the tread band 12 extends astride the equatorial plane X-X of the front tire 1 and has a width of from about 10% to about 35% of the axial development of the tread band 12.

Still more preferably, the central zone E extends astride the equatorial plane X-X of the front tire 1 and has a width of from about 15% to about 25% of the axial development of the tread band 12.

In the preferred embodiment illustrated and in order to enhance the water draining capacity of the front tire 1, the central zone E of the tread band 12 has a sea/land ratio between about 15% and about 30% and, still more preferably, between about 20% and about 25%

Most preferably, the tread band 12 of the front tire 1 further comprises axially opposite intermediate side zones C, D lying between the central zone E and said shoulder zones F, G, each of said intermediate side zones C, D having a width of from about 15% to about 35% of the axial development of the tread band and a sea/land ratio between about 10% and about 30%.

More preferably, the intermediate side zones C, D having a width of from about 15% to about 25% of the axial development of the tread band and a sea/land ratio between about 15% and about 25%.

In the preferred embodiment illustrated, the transversal grooves 14 formed in the tread band 12 are substantially curvilinear so as to conform as much as possible to the so-called wear waves of the tread band.

Preferably, the transversal grooves 14 form with the running direction RD of the front tire 1 which is parallel to the equatorial plane X-X of the front tire 1 an angle α of from about 30° to about 60° and, more preferably, from about 40° to about 50°.

As mentioned hereinabove, such an angle α is defined by the tangent to the transversal grooves 14 at the intersection between the transversal grooves 14 and a circumferential line L bisecting each of the half portions of the tread band 12 defined by the equatorial plane X-X of the front tire, with the running direction RD of the front tire 1 as measured upstream of the transversal grooves 14 (see FIG. 2).

In the preferred embodiment illustrated, the transversal grooves 14 have a curvature radius R1 of from about 40 to about 200 mm and, more preferably, from about 60 to about 120 mm as measured from a curvature center CC positioned along the aforementioned circumferential line L.

In the preferred embodiment illustrated, part of the transversal grooves 14 are connected to the circumferential groove 13.

Preferably, furthermore, the transversal grooves 14 formed in the tread band of the front tire are circumferentially distributed along the tread band 12 in axially opposite groups comprising two transversal grooves which in the preferred embodiment illustrated are both connected to the circumferential groove 13.

In the preferred embodiment illustrated, furthermore, the axially opposite groups of transversal grooves 14 are circumferentially staggered while the tread band 12 further comprises one transversal groove 16 formed on either side of the equatorial plane X-X of the front tire 1 between said axially opposite and circumferentially staggered groups of transversal grooves 14.

Preferably, this additional circumferentially “intermediate” transversal groove 16 is preferably provided with an axially inner end 16a substantially lying at the borderline between the central zone E and the axially opposite intermediate side zones C, D of the tread band 12.

Preferably, all the transversal grooves 14, 16 formed in the tread band 12 of the front tire 1 are also substantially parallel to one another.

Additionally, the circumferential groove 13 axially crosses the equatorial plane X-X of the front tire 1 in a substantially winding fashion and preferably comprises a plurality of curvilinear segments 13a, 13b having respective circumferentially staggered centers of curvature CD positioned at opposite sides of the equatorial plane X-X of the front tire 1.

Preferably, the curvilinear segments 13a, 13b have a curvature radius R2 of from about 40 to about 300 mm and, still more preferably, of from about 60 to about 180 mm.

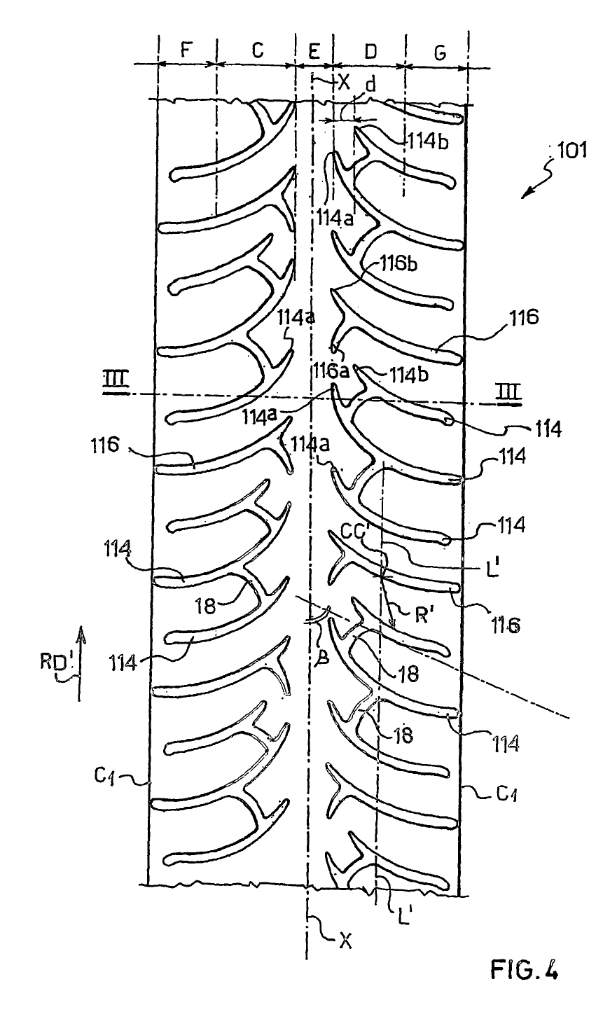

With reference to FIGS. 3 and 4, the rear tire 101 forming the pair of tires according to the present invention will now be described.

In the following description and in such figures, the elements of the rear tire 101 which are structurally or functionally equivalent to those previously illustrated with reference to the front tire 1 shown in FIGS. 1 and 2 will be indicated with the same reference numerals and will not be described any further.

According to a preferred embodiment of the present invention, the rear tire 101 has a curvature ratio lower than the front tire.

The belt structure 8 can be constituted by a single layer 8a including cords 9 forming a plurality of circumferential coils 9a, substantially oriented according to the rolling direction of the tire or “zero degree” cords. These cords can be analogous to those described for the front tire.

In the preferred embodiment illustrated in FIG. 4, the tread band 12 of the rear tire 101 comprises an area defining a substantially null sea/land ratio within a central zone E thereof extending astride the equatorial plane X-X of the rear tire 101 and having a width of from about 5% to about 30% of the axial development of the tread band 12.

Still more preferably, the central zone E has a width of from about 10% to about 35% of the axial development of the tread band 12.

In the preferred embodiment illustrated, the tread band 12 of the rear tire 101 comprises a plurality of transversal grooves 114 alternately extending from the central zone E towards axially opposite shoulder zones F, G external to the central zone E.

Preferably, at least some of the transversal grooves 114 have an axially inner end 114a substantially lying at the borderline between the central zone E and axially opposite intermediate side zones C, D of the tread band 12 lying between the central zone E and the shoulder zones F, G of the tread band 12.

Preferably, each of said intermediate side zones C, D has a width of from about 15% to 35% and, more preferably, of from about 20% to 30%, of the axial development of the tread band and a sea/land ratio between about 10% and about 30% and, more preferably, of from about 15% to 25%.

In the preferred embodiment illustrated, the transversal grooves 114 formed in the tread band 12 of the rear tire 101 are substantially curvilinear so as to conform as much as possible to the so-called wear waves of the tread band.

Preferably, the transversal grooves 114 formed in the tread band 12 of the rear tire 101 form with the running direction RD′ of the rear tire 101 an angle β of from about 30° to about 60° and, more preferably, of from about 40° to about 50°.

As mentioned hereinabove, such an angle β is defined by the tangent to the transversal grooves 114 at the intersection between the transversal grooves 114 and a circumferential line L′ bisecting each of the half portions of the tread band 12 defined by the equatorial plane X-X of the rear tire 101, with the running direction RD′ of the tire 101 as measured downstream of the transversal grooves 114 (see FIG. 4).

Preferably, just to better follow the aforesaid wear waves, the transversal grooves 114 formed in the tread band 12 of the rear tire 101 have a curvature center CC′ positioned upstream of the same at the opposite intermediate side zones C, D of the tread band 12, external to said central zone E.

In such intermediate side zones C, D, the transversal grooves 114 formed in the tread band 12 of the rear tire preferably have a curvature radius R1′ of from about 60 to about 240 mm and, still more preferably, of from about 80 to about 160 mm, as measured from a curvature center CC′ positioned along a circumferential line L′ bisecting each of the half portions of the tread band 12 defined by the equatorial plane X-X of the rear tire 101.

In the preferred embodiment illustrated, the transversal grooves 114 formed in the tread band 12 of the rear tire 101 are circumferentially distributed in axially opposite groups each comprising three transversal grooves 114.

Preferably, said axially opposite groups of transversal grooves 114 are circumferentially staggered.

Preferably, furthermore, at least one of the three transversal grooves 114 belonging to each of said axially opposite groups of transversal grooves has an axially inner end 114b lying at a predetermined distance d from the borderline between the central zone E and awdally opposite intermediate side zones C, D of the tread band 12.

In this way it is advantageously possible to improve the wet performance of the rear tire while running along a bend.

In the preferred embodiment illustrated, the rear tire 101 further comprises a plurality of transversal grooves 116 formed in the tread band 12 on either side of the equatorial plane X-X of the rear tire 101 between said axially opposite and circumferentially staggered groups of transversal grooves 114.

Preferably, the transversal grooves 116 have a couple of axially inner ends 116a, 116b substantially lying at the borderline between the central zone E and axially opposite intermediate side zones C, D of the tread band 12 lying between the central zone E and the shoulder zones F, G of the tread band 12.

Preferably, furthermore, the transversal grooves 114, 116 formed in the tread band 12 of the rear tire 101 are substantially parallel to one another.

In the preferred embodiment illustrated, at least some of the transversal grooves 114 formed in the tread band 12 of the rear tire 101 and, more specifically, the transversal grooves 114 included in said axially opposite and circumferentially staggered groups of transversal grooves, are circumferentially interconnected by bridging grooves 18.

In the preferred embodiment illustrated, furthermore, at least some and preferably all of the transversal grooves 114, 116 formed in the tread band 12 of the rear tire 101 are provided with an end portion or with a couple of end portions which are substantially tapered. In other words, the end portions of the transversal grooves 114, 116 have a V-shaped configuration, having a width progressively decreasing towards the equatorial plane X-X of the rear tire 101.

In accordance with the invention, a motorcycle equipped with a front tire 1 and a rear tire 101 as described above mounted, respectively, on its front wheel and on its rear wheel may advantageously achieve: better performances on both wet and dry ground coupled with an enhanced kilometric yield, wear uniformity and traction characteristics of such a pair of tires.

According to a preferred embodiment of the invention, a method of improving the performance on both wet and dry ground of such a motorcycle comprises, in particular, the steps of:
a) enhancing the water draining capacity of the front tire 101 under its ground contacting area within the central zone E extending astride the equatorial plane X-X of the front tire 1;
b) enhancing the traction capacity of the rear tire 101 by providing a substantially null sea/land ratio within the central zone E of the tread band 12 extending astride the equatorial plane X-X of the rear tire 101.

Repeated tests carried out by the Applicant have shown that the pair of motorcycle tires according to the invention, are capable of solving in an entirely satisfactory way the posed problem of improving both the performance on wet ground and the kilometric yield, wear uniformity and traction characteristics of motorcycle tires.

These results and especially the improvement of the performance on wet ground could be considered entirely surprising taking into account that they are achieved by reducing in the rear tractive tire the number of grooves in the most critical area, i.e. the central zone of the tread band, that is by reducing the number of those structural elements—the grooves—delegated to drain the water away from the ground contacting area.

Obviously, those skilled in the art may introduce variants and modifications in the above described invention, in order to satisfy specific and contingent requirements, which variants and modifications fall anyhow within the scope of protection as is defined by the appended claims.

1-37. (canceled)

38. A pair of pneumatic tires for a motorcycle, comprising:
a front tire; and
a rear tire;
wherein each tire comprises a tread band provided with a plurality of grooves,
wherein the tread band of the front tire comprises:
at least one circumferential groove; and
a plurality of transverse grooves;
wherein the at least one circumferential groove extends at an equatorial plane of the front tire within a central zone of the tread band of the front tire,
wherein the central zone of the tread band of the front tire extends astride the equatorial plane of the front tire,
wherein the transverse grooves comprise axially inner ends lying within the central zone of the tread band of the front tire,
wherein the transverse grooves alternately extend from the central zone of the tread band of the front tire toward axially opposite shoulder zones of the tread band of the front tire,
wherein the axially opposite shoulder zones of the tread band of the front tire are axial external to the central zone of the tread band of the front tire,
wherein at least some of the transverse grooves are connected to the at least one circumferential groove,
wherein the tread band of the rear tire comprises:
an area defining a substantially null sea/land ratio within a central zone of the tread band of the rear tire;
wherein the central zone of the tread band of the rear tire extends astride an equatorial plane of the rear tire, and
wherein the central zone of the tread band of the rear tire has a width greater than or equal to about 5% and less than or equal to about 30% of an axial development of the tread band of the rear tire.

39. The pair of tires of claim 38, the central zone of the tread band of the front tire has a width greater than or equal to about 10% and less than or equal to about 35% of an axial development of the tread band of the front tire.

40. The pair of tires of claim 38, wherein the central zone of the tread band of the front tire has a sea/land ratio greater than or equal to about 15% and less than or equal to about 30%.

41. The pair of tires of claim 38, wherein the tread band of the front tire further comprises:
axially opposite intermediate side zones lying between the central zone and the shoulder zones;
wherein each of the intermediate side zones has a width greater than or equal to about 15% and less than or equal to about 35% of an axial development of the tread band of the front tire, and
wherein each of the intermediate side zones has a sea/land ratio greater than or equal to about 15% and less than or equal to about 35%.

42. The pair of tires of claim 38, wherein the transverse grooves in the tread band of the front tire are substantially curvilinear.

43. The pair of tires of claim 38, wherein the transverse grooves in the tread band of the front tire define, with a running direction of the front tire, a first angle greater than or equal to about 30° and less than or equal to about 60°.

44. The pair of tires of claim 42, wherein the transverse grooves in the tread band of the front tire have a radius of curvature greater than or equal to about 40 mm and less than or equal to about 200 mm as measured from a curvature center positioned along a circumferential line bisecting each half portion of the tread band defined by the equatorial plane of the front tire.

45. The pair of tires of claim 38, wherein the transverse grooves in the tread band of the front tire are circumferentially distributed along the tread band in axially opposite groups comprising at least two transverse grooves.

46. The pair of tires of claim 45, wherein the axially opposite groups of transverse grooves are circumferentially staggered.

47. The pair of tires of claim 46, wherein the tread band of the front tire further comprises:
at least one transverse groove in the tread band of the front tire on either side of the equatorial plane of the front tire between the axially opposite and circumferentially staggered groups of transverse grooves.

48. The pair of tires of claim 38, wherein the transverse grooves in the tread band of the front tire are substantially parallel to one another.

49. The pair of tires of claim 38, wherein the at least one circumferential groove in the tread band of the front tire axially crosses the equatorial plane of the front tire in a substantially winding fashion.

50. The pair of tires of claim 49, wherein the at least one circumferential groove comprises a plurality of curvilinear segments having respective circumferentially staggered centers of curvature positioned at opposite sides of the equatorial plane of the front tire.

51. The pair of tires of claim 50, wherein the curvilinear segments have a radius of curvature greater than or equal to about 40 mm and less than or equal to about 300 mm.

52. The pair of tires of claim 38, wherein the rear tire has a curvature ratio lower than the front tire.

53. The pair of tires of claim 38, wherein the tread band of the rear tire further comprises:
a plurality of transverse grooves alternately extending from the central zone of the tread band of the rear tire toward axially opposite shoulder zones of the tread band of the rear tire;
wherein the axially opposite shoulder zones of the tread band of the rear tire are axial external to the central zone of the tread band of the rear tire.

54. The pair of tires of claim 53, wherein the tread band of the rear tire further comprises:
axially opposite intermediate side zones lying between the central zone and the shoulder zones,
wherein each of the intermediate side zones has a width greater than or equal to about 15% and less than or equal to about 35% of an axial development of the tread band of the rear tire, and
wherein each of the intermediate side zones has a sea/land ratio greater than or equal to about 10% and less than or equal to about 30%.

55. The pair of tires of claim 53, wherein the transverse grooves in the tread band of the rear tire are substantially curvilinear.

56. The pair of tires of claim 53, wherein the transverse grooves in the tread band of the rear tire define, with a running direction of the rear tire, a second angle greater than or equal to about 30° and less than or equal to about 60°.

57. The pair of tires of claim 53, wherein the transverse grooves in the tread band of the rear tire have a radius of curvature greater than or equal to about 60 mm and less than or equal to about 240 mm as measured from a curvature center positioned along a circumferential line bisecting each half portion of the tread band defined by the equatorial plane of the rear tire.

58. The pair of tires of claim 53, wherein the transverse grooves in the tread band of the rear tire are circumferentially distributed along the tread band of the rear tire in axially opposite groups comprising at least two transverse grooves.

59. The pair of tires of claim 58, wherein the axially opposite groups of transverse grooves are circumferentially staggered.

60. The pair of tires of claim 59, wherein the tread band of the rear tire further comprises:
at least one transverse groove in the tread band of the rear tire on either side of the equatorial plane of the rear tire between the axially opposite and circumferentially staggered groups of transverse grooves.

61. The pair of tires of claim 53, wherein the transverse grooves in the tread band of the rear tire are substantially parallel to one another.

62. The pair of tires of claim 53, wherein at least some of the transverse grooves in the tread band of the rear tire are circumferentially interconnected by bridging grooves.

63. The pair of tires of claim 53, wherein at least some of the transverse grooves in the tread band of the rear tire are provided with a tapered end portion having a width progressively decreasing toward the equatorial plane of the rear tire.

64. A motorcycle with the pair of tires of claim 38 mounted on respective front and rear wheels of the motorcycle.

65. A method of improving performance on both wet and dry ground of a motorcycle, the motorcycle comprising a pair of pneumatic tires mounted on respective front and rear wheels of the motorcycle;
the pair of tires comprising:
a front tire; and
a rear tire;
wherein each tire comprises a tread band provided with a plurality of grooves,
the method comprising:
enhancing water-draining capacity of the front tire under a ground contacting area within a central zone of the tread band of the front tire; and
enhancing traction capacity of the rear tire by providing a substantially null sea/land ratio within a central zone of the tread band of the rear tire;
wherein the central zone of the tread band of the front tire extends astride an equatorial plane of the front tire, and
wherein the central zone of the tread band of the rear tire extends astride an equatorial plane of the rear tire.

66. The method of claim 65, wherein enhancing water-draining capacity of the front tire comprises:
providing the tread band of the front tire with a plurality of transverse grooves;
wherein the transverse grooves comprise axially inner ends lying within the central zone of the tread band of the front tire,
wherein the transverse grooves alternately extend from the central zone of the tread band of the front tire toward axially opposite shoulder zones of the tread band of the front tire, and
wherein the axially opposite shoulder zones of the tread band of the front tire are axial external to the central zone of the tread band of the front tire.

67. The method of claim 65, wherein enhancing water-draining capacity of the front tire comprises:
providing the central zone of the tread band of the front tire with a width greater than or equal to about 10% and less than or equal to about 35% of an axial development of the tread band of the front tire; and
providing the central zone of the tread band of the front tire with a sea/land ratio greater than or equal to about 15% and less than or equal to about 30%.

68. The method of claim 65, wherein enhancing water-draining capacity of the front tire comprises:
providing at least one circumferential groove extending at the equatorial plane of the front tire.

69. The method of claim 68, wherein at least some of the transverse grooves are connected to the at least one circumferential groove.

70. The method of claim 65, further comprising:
providing the tread band of the front tire with a plurality of transverse grooves;
wherein in axially opposite intermediate side zones lying between the central zone and axially opposite shoulder zones, the transverse grooves of the tread band of the front tire define a sea/land ratio greater than or equal to about 15% and less than or equal to about 35%, and
wherein each of the intermediate side zones has a width greater than or equal to about 15% and less than or equal to about 35% of an axial development of the tread band of the front tire.

71. The method of claim 70, wherein the transverse grooves in the tread band of the front tire define, with a running direction of the front tire, a first angle greater than or equal to about 30° and less than or equal to about 60°.

72. The method of claim 65, further comprising:
enhancing water-draining capacity of the rear tire by providing the tread band of the rear tire with a plurality of transverse grooves;
wherein the transverse grooves alternately extend from the central zone of the tread band of the rear tire toward axially opposite shoulder zones of the tread band of the rear tire, and
wherein the axially opposite shoulder zones of the tread band of the rear tire are axial external to the central zone of the tread band of the rear tire.

73. The method of claim 72, wherein in axially opposite intermediate side zones lying between the central zone and the shoulder zones, the transverse grooves of the tread band of the rear tire define a sea/land ratio greater than or equal to about 10% and less than or equal to about 30%, and
wherein each of the intermediate side zones has a width greater than or equal to about 15% and less than or equal to about 35% of an axial development of the tread band of the rear tire.

74. The method of claim 72, wherein the transverse grooves in the tread band of the rear tire define, with a running direction of the rear tire, a second angle greater than or equal to about 30° and less than or equal to about 60°.
